(19) United States
(12) Patent Application Publication
(10) Pub. No.: US 2020/0311214 A1
(43) Pub. Date: Oct. 1, 2020

(54) SYSTEM AND METHOD FOR GENERATING THEME BASED SUMMARY FROM UNSTRUCTURED CONTENT

(71) Applicant: Wipro Limited, Bangalore (IN)

(72) Inventors: Arindam CHATTERJEE, Gondalpara (IN); Manjunath Ramachandra Iyer, Bangalore (IN)

(21) Appl. No.: 16/433,146

(22) Filed: Jun. 6, 2019

(30) Foreign Application Priority Data
Mar. 30, 2019 (IN) 201941012783

(51) Int. Cl. G06F 17/28; G06F 17/27; G06F 16/332; G06F 16/35

(52) U.S. Cl. CPC G06F 17/2881; G06F 16/35; G06F 16/3326; G06F 17/2785

(57) ABSTRACT

A method and system for generating theme based summary from unstructured content is disclosed. The method includes assigning a sentiment category of a plurality of sentiment categories to each of a plurality of sets of words. The method further includes segregating the plurality of sets of words based on the assigned sentiment category. The method may further include processing for each of the plurality of sets of words each word in a set of words of the plurality of sets of words as a neuron in the first neural network. The method may further include determining for each of the plurality of sets of words a relevancy score for each neuron relative to an associated sentiment category. The method may further include generating a summary from the unstructured text, based on the relevancy score determined for each neuron.

### TECHNICAL FIELD

This disclosure relates generally to generating summary and more particularly to system and method for generating theme based summary from unstructured content.

### BACKGROUND

Extracting text or content, which is related to a specific theme and a topic, from online documents, which may include webpages, tweets, blogs, posts or the like, may be challenging as the text (relevant to the theme) may be dispersed throughout the text base. The problem gets compounded when the sentences of the theme may be further polarized to fall in to one of the classes. The scenario may be frequently encountered in the analysis of user feedback on a variety of products, marketing campaigns, or the like. Additionally, when users express their views on social media and online reviews and blogs in an unstructured manner, the extraction of relevant text related to a theme becomes a bigger challenge. In other words, the customer feedback may be dispersed over multiple places in an unstructured format.

To solve the above issue, some conventional methods discloses weightage-based method for considering multiple source and providing output in pre-determined format and a mechanism for extracting theme-based information from social media, which may be useful for business purpose. Additionally, the conventional method may discloses a mechanism for analysis of user generated content, which captures, extracts, analyzes, categorizes, synthesizes, summarizes and displays, in a customizable format.

However, the conventional systems may not be able to efficiently generate contextual and relevant feedback summary based on user query and provided theme. Moreover, the conventional systems increase the work load of users, as they have to mine through these feedbacks to identify and generate relevant data that may be required. The conventional systems may also require supervised learning that may reduce overall efficiency and requires a lot of initial training dataset, which may either be not readily available or may require time-consuming and effort intensive manual annotation. The conventional systems may also not have context aware semantic analysis capabilities and therefore the conventional systems may be incapable of presenting relevant customer feedback on demand.

### SUMMARY

In one embodiment, a method of generating theme based summary from unstructured content is disclosed. The method may include assigning a sentiment category of a plurality of sentiment categories to each of a plurality of sets of words extracted from an unstructured content, based on a first neural network that includes a plurality of layers. It should be noted that a first layer of the plurality of layers receives unstructured content and a last layer of the plurality of layers generates sentiment categories for each of the plurality of sets of words, and the unstructured content is associated with a topic category assigned by a user. The method may further include segregating the plurality of sets of words based on the assigned sentiment category. The method may further include processing for each of the plurality of sets of words each word in a set of words of the plurality of sets of words as a neuron in the first neural network, through an explainable extraction algorithm. The method may further include determining for each of the plurality of sets of words a relevancy score for each neuron relative to an associated sentiment category, based on an activation function associated with the explainable extraction algorithm. The method may further include generating a summary from the unstructured text, based on the relevancy score determined for each neuron associated with each word in the plurality of sets of words and a theme selected by the user within the topic category. It should be noted that the theme selected by the user is associated with at least one of the plurality of sentiment categories

In another embodiment, a content summarizing device for generating theme based summary from unstructured content is disclosed. The content summarizing device includes a processor and a memory communicatively coupled to the processor, wherein the memory stores processor instructions, which, on execution, causes the processor to assign a sentiment category of a plurality of sentiment categories to each of a plurality of sets of words extracted from an unstructured content, based on a first neural network that includes a plurality of layers. It should be noted that a first layer of the plurality of layers receives unstructured content and a last layer of the plurality of layers generates sentiment categories for each of the plurality of sets of words, and the unstructured content is associated with a topic category assigned by a user. The processor instructions further cause the processor to segregate the plurality of sets of words based on the assigned sentiment category. The processor instructions further cause the processor to process for each of the plurality of sets of words, each word in a set of words of the plurality of sets of words as a neuron in the first neural network, through an explainable extraction algorithm. The processor instructions further cause the processor determine for each of the plurality of sets of words a relevancy score for each neuron relative to an associated sentiment category, based on an activation function associated with the explainable extraction algorithm. The processor instruction further cause the processor to generate a summary from the unstructured text, based on the relevancy score determined for each neuron associated with each word in the plurality of sets of words and a theme selected by the user within the topic category. It should be noted that the theme selected by the user is associated with at least one of the plurality of sentiment categories.

In yet another embodiment, a non-transitory computer-readable storage medium is disclosed. The non-transitory computer-readable storage medium has instructions stored thereon, a set of computer-executable instructions causing a computer that includes one or more processors to perform steps of assigning a sentiment category of a plurality of sentiment categories to each of a plurality of sets of words extracted from an unstructured content, based on a first neural network that includes a plurality of layers, wherein a first layer of the plurality of layers receives unstructured content and a last layer of the plurality of layers generates sentiment categories for each of the plurality of sets of words, and wherein the unstructured content is associated with a topic category assigned by a user; segregating the plurality of sets of words based on the assigned sentiment category; processing for each of the plurality of sets of words each word in a set of words of the plurality of sets of words as a neuron in the first neural network, through an explainable extraction algorithm; determining for each of the plurality of sets of words a relevancy score for each neuron relative to an associated sentiment category, based on an activation function associated with the explainable extraction algorithm; and generating a summary from the unstructured text, based on the relevancy score determined for each neuron associated with each word in the plurality of sets of words and a theme selected by the user within the topic category, wherein the theme selected by the user is associated with at least one of the plurality of sentiment categories.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for generating theme based summary from unstructured content, in accordance with an embodiment.

FIG. 2 is a block diagram illustrating various modules within a memory of a content summarizing device configured to generating theme based summary from unstructured content, in accordance with an embodiment.

FIG. 3 illustrates a flowchart of a method for generating theme based summary from unstructured content, in accordance with an embodiment.

FIG. 4 illustrates a trained RNN that includes various layers configured to assign a sentiment category to a set of words, in accordance with an exemplary embodiment.

FIG. 5 illustrates a flowchart of a method for generating a summary from unstructured text based on relevancy scores determined for each neuron associated with words in the plurality of sets of words and a theme selected by a user, in accordance with an embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

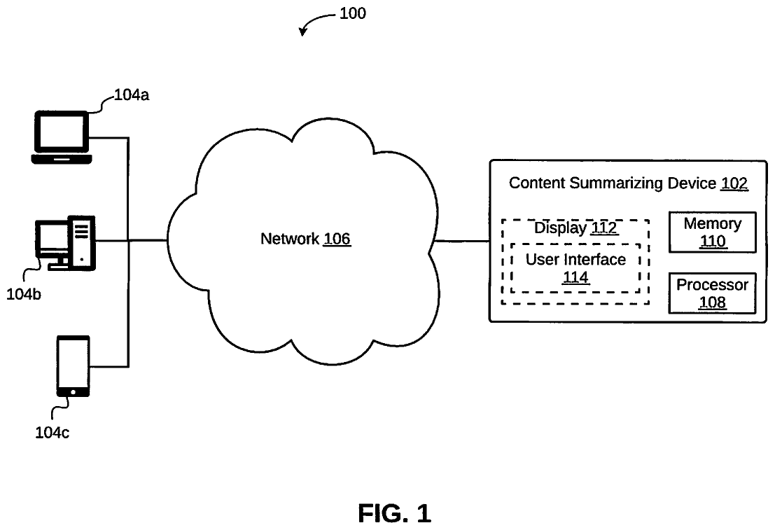

Referring now to FIG. 1, is a block diagram of an exemplary system 100 for generating theme based summary from unstructured content is illustrated, in accordance with an embodiment. The system 100 may include a content summarizing device 102 that may be configured to generate theme based summary from unstructured content. Examples of the content summarizing device 102 may include, but are not limited to an application server, a laptop, a desktop, a smart phone, or a tablet. The unstructured text, for example, may be feedback provided by users on different forums, for example, TWITTER, FACEBOOK, blogs, online consumer forums, or websites. Since the users do not follow any particular format while providing their feedback, the feedback is unstructured. In other words, the feedback does not adhere to any predefined uniform format and it may vary considerably based on the forum. By way of an example, while providing positive feedback, a user may mix the positive feedback with some negative feedback as well. As a result, there is a very high chance that a reviewer may miss out on the negative feedback, while reviewing the positive feedback.

Thus, it is important to identify and generate a relevant summary from unstructured text, which is based on a theme as required by a reviewer. The theme, for example, may include, but is not limited to positive feedback, negative feedback, neutral feedback, very positive feedback, or very negative feedback. In other words, if the reviewer want to only look at the negative feedback (theme selected by the reviewer), the content summarizing device 102 may generate a summary from unstructured feedback that only includes relevant negative feedback, even when the negative feedback is provided within a positive feedback. Additionally, the reviewer may also be able to specify a source (forum) from where the feedback may be extracted along with a specific topic that is of interest to the reviewer. By way of an example, a reviewer may want to get a hold of condescending tweets on a marketing campaign. Thus, the theme in this case is: “tweets that are demeaning,” the topic is the marketing campaign, and the source is TWITTER. In this case, the content summarizing device 102 may adhere to the theme specified by the reviewer and generate a summary of the feedback that includes condescending comments about the marketing campaign on TWITTER.

The unstructured content may be provided by one or more users through one or more of a plurality of computing devices 104 (for example, a laptop 104a, a desktop 104b, and a smart phone 104c). Other examples of the plurality of computing devices 104 may include, but are not limited to a server or an application server, which may store unstructured content provided by one or more users. The plurality of computing devices 104 may be communicatively coupled to the content summarizing device 102 via a network 106. The network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

In order to generate theme based summary from unstructured text, the content summarizing device 102 may include a processor 108 that is communicatively coupled to a memory 110, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

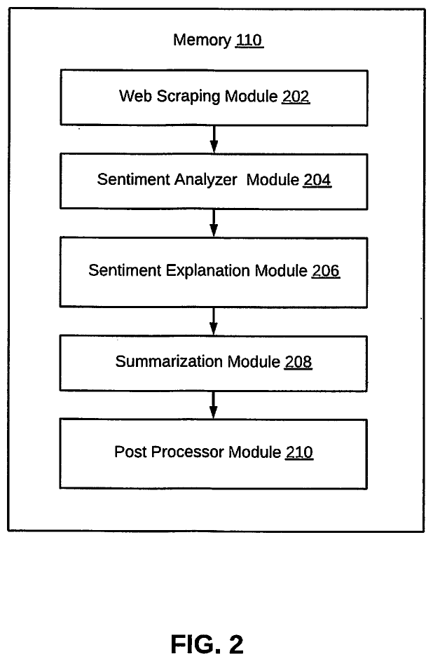

The memory 110 may further include various modules that enable the content summarizing device 102 to generate theme based summary from unstructured text. These modules are explained in detail in conjunction with FIG. 2. The content summarizing device 102 may further include a display 112 having a User Interface (UI) 114 that may be used by a user or an administrator to provide queries (either verbal or textual) and various other inputs to the content summarizing device 102. The display 112 may further be used to display a result of various analysis performed by the content summarizing device 102. The functionality of the content summarizing device 102 may alternatively be configured within each of the plurality of computing devices 104.

Referring now to FIG. 2, a block diagram of various modules within the memory 110 of the content summarizing device 102 configured to generate theme based summary from unstructured content is illustrated, in accordance with an embodiment. The memory 110 includes a web scraping module 202, a sentiment analyzer module 204, a sentiment explanation module 206, a summarization module 208, and a post processor module 210.

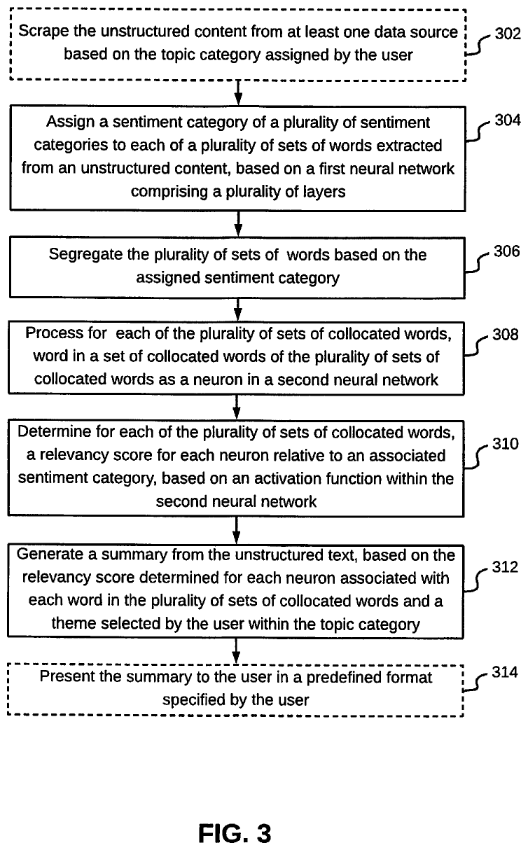

The web scraping module 202 may scrape the unstructured content from one or more data sources based on a topic category assigned by a user. The content summarizing device 102 may use web scraping or crawling techniques to extract the unstructured content. The unstructured content, for example, may be feedback provided by multiple users in response to a particular service, product, or a campaign. The one or more data sources may also be specified by the user and the examples may include, but are not limited to TWITTER, FACEBOOK, blogs, or websites. This is further explained in detail in conjunction with FIG. 3.

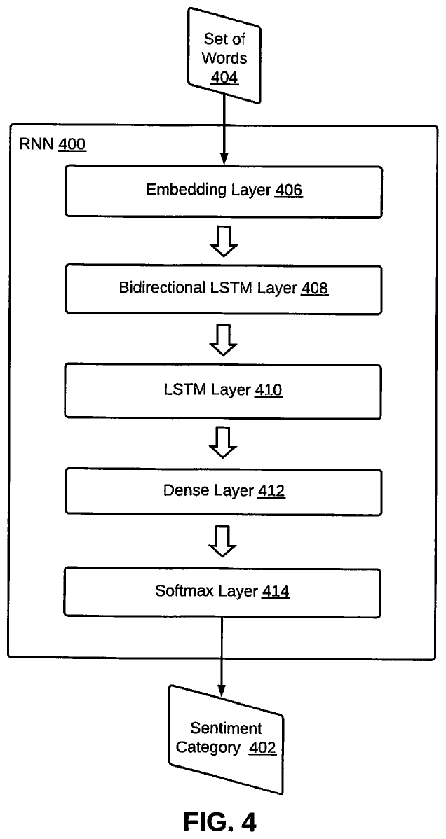

Thereafter, the sentiment analyzer module 204 assigns a sentiment category of a plurality of sentiment categories to each of a plurality of sets of words extracted from an unstructured content. The plurality of sentiment categories may include, but are not limited to a positive sentiment category, a negative sentiment category, a very positive sentiment category, a very negative sentiment category, or a neutral sentiment category. The sentiment category may be assigned based on a first neural network that includes a plurality of layers. A first layer of the plurality of layers may receive the unstructured content and a last layer of the plurality of layers may generate sentiment categories for each of the plurality of sets of words. This is further explained in detail in conjunction with FIG. 3 and FIG. 4.

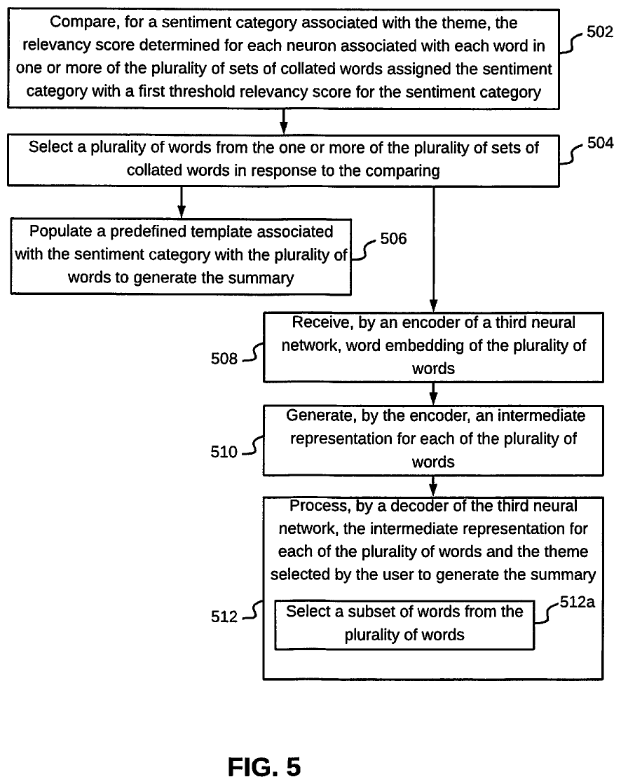

For each of the plurality of sets of words, the sentiment explanation module 206 may process each word in a set of words of the plurality of sets of words as a neuron in the first neural network. In other words, for a set of words that has been categorized in a given semantic category, each word in that set of words may be processed as a neuron in the first neural network. The processing is done to find explanations for the segregations performed by the sentiment analyzer module 204. The sentiment explanation module 206 may perform the processing through an explainable extraction algorithm. The sentiment explanation module 206, for each of the plurality of sets of words, may further determine a relevancy score for each neuron relative to an associated sentiment category. This is further explained in detail in conjunction with FIG. 3 and FIG. 5.

For a sentiment category associated with a theme selected by the user, the summarization module 208 may compare the relevancy score determined for each neuron associated with each word in one or more of the plurality of sets of words that is assigned the sentiment category with a first threshold relevancy score. The first threshold relevancy score may be specific to the sentiment category. The summarization module 208 then selects a plurality of words from the one or more of the plurality of sets of words in response to the comparing. The relevancy scores of neurons associated with the plurality of words is above the first threshold relevancy score.

The summarization module 208 may include a second neural network, such that, an encoder of the second neural network may receive word embeddings of the plurality of words. The second neural network may be trained to generate natural language sentences based on input words. Thereafter, the encoder may generate an intermediate representation for each of the plurality of words. A decoder of the second neural network may then process the intermediate representation for each of the plurality of words and the theme selected by the user to generate the summary. This is further explained in detail in conjunction with FIG. 5.

Once the summary is generated, the post processor module 210 presents the summary to the user in a predefined format as specified by the user. In other words, once a feedback summary is available, the summary is packaged and combined in the user's desired format and accordingly forwarded to the user. This is further explained in detail in conjunction with FIG. 3.

Referring now to FIG. 3, a flowchart of a method for generating theme based summary from unstructured content is illustrated, in accordance with an embodiment. At step 302, the content summarizing device 102 may scrape the unstructured content from one or more data sources based on a topic category assigned by a user. The content summarizing device 102 may use web scraping or crawling techniques to extract the unstructured content. The unstructured content, for example, may be feedback provided by multiple users in response to a particular service, product, or a campaign. The one or more data sources may also be specified by the user and the examples may include, but are not limited to TWITTER, FACEBOOK, blogs, or websites. The topic category provided by the user may be a well-formed topic category, which can be used to scrape data set that includes unstructured content (feedback texts), which may be used to generate a summary for the unstructured text, as explained below.

At step 304, the content summarizing device 102 assigns a sentiment category of a plurality of sentiment categories to each of a plurality of sets of words extracted from an unstructured content. The plurality of sentiment categories may include, but are not limited to a positive sentiment category, a negative sentiment category, a very positive sentiment category, a very negative sentiment category, or a neutral sentiment category. A set of words, for example, may be a single TWEET, a single FACEBOOK post, or a comment on a website or Blog. Alternatively, a set of words, for example, may include a subset of one of the following: a single TWEET, a single FACEBOOK post, or a comment on a website or Blog. By way of an example, the set of words may include two or more words extracted from a particular TWEET.

The sentiment category may be assigned based on a first neural network that includes a plurality of layers. A first layer of the plurality of layers may receive the unstructured content and a last layer of the plurality of layers may generate sentiment categories for each of the plurality of sets of words. In an embodiment, the neural network may be trained using a dataset extracted from Stanford sentiment bank. The neural network may be a Recurrent Neural Network (RNN). The neural network, which is an RNN, may include an embedding layer, a Bidirectional Long Short Term Memory (LSTM) layer, a LSTM layer, a dense Layer, and Softmax Layer. In this case, the first layer is the embedding layer and the last layer is the Softmax layer. This is further depicted in conjunction with FIG. 4.

At step 306, the content summarizing device 102 segregates the plurality of sets of words based on the assigned sentiment category. In an embodiment, five boxes (or tables) may be created, such that, each box corresponds to a sentiment category. By way of an example, TWEETS that are negative are segregated into a box associated with the negative sentiment category and TWEETS that are positive are segregated into a box associated with the positive sentiment category.

At step 308, for each of the plurality of sets of words, the content summarizing device 102 may process each word in a set of words of the plurality of sets of words as a neuron in the first neural network. In other words, for a set of words that has been categorized in a given semantic category, each word in that set of words may be processed as a neuron in the first neural network. The processing is done to find explanations for the segregations performed at step 306. The content summarizing device 102 may perform the processing through an explainable extraction algorithm, which, for example, may include, but is not limited to Layer-wise Relevance Propagation (LRP) algorithm. The LRP algorithm may determine contribution of each word (or the relevance of each input feature) in prediction of a sentiment category for a given set of words.

At step 310, for each of the plurality of sets of words, the content summarizing device 102 may determine a relevancy score for each neuron relative to an associated sentiment category. The content summarizing device 102 may determine the relevancy scores based on an activation function associated with the explainable extraction algorithm. By way of an example, the LRP algorithm determines the relevance of each neuron in each layer of the first neural network for a given set of words. Each neuron (which corresponds to a word in the given set of words) may either have a positive or a negative relevance to the associated sentiment category. The activation function used by the LRP algorithm is represented by equation 1 given below:

$${R}_{i} = {\sum }_{j} \frac{{a}_{i} {w}_{i j}^{+}}{{\sum }_{i} {a}_{i} {w}_{i j}^{+}} \qquad ( 1 )$$

In the equation 1, ai and aj are the activations, wij represent weights of connections, Ri represents a relevance score for a neuron (representation for a word). The relevancy score determined for a neuron relative to an associated sentiment category indicates relevancy of a word associated with the neuron to the associated sentiment category.

Based on the relevancy score determined for each neuron associated with each word in the plurality of sets of words and a theme selected by the user within the topic category, the content summarizing device 102, at step 312, may generate a summary from the unstructured text. The theme selected by the user may be associated with one or more of the plurality of sentiment categories. In an embodiment, a pre-decided list of objectives is created, such that, the list of objectives is populated using a plurality of themes that may be selected by a user. The user may select one of the objectives from the list of objectives, based on the users' personal requirement and goal. Each of the plurality of themes is further mapped to one or more of the plurality of sentiment categories.

In an embodiment, for a sentiment category associated with the theme, the relevancy score determined for each neuron associated with each word in a set of words assigned to the sentiment category, is compared with a first threshold relevancy score for that sentiment category. This is further explained in detail in conjunction with FIG. 5.

At step 314, the content summarizing device 102 presents the summary to the user in a predefined format as specified by the user. In other words, once a feedback summary is available, the summary is packaged and combined in the user's desired format and accordingly forwarded to the user. In case the user has not specified a preferred format, the summary is forwarded in natural language text format. If an embodiment, the user may also be provided with key words (or features) that are for or against a particular theme, for which the summary was generated.

Referring now to FIG. 4, a trained RNN 400 that includes various layers configured to assign a sentiment category 402 to a set of words 404 is illustrated, in accordance with an exemplary embodiment. The trained RNN 400 is provided the set of words 404 as an input, which is processed in a sequence by an embedding layer 406, a bidirectional LSTM layer 408, an LSTM layer 410, a dense layer 412, and a Softmax layer 414 (or a sigmoid layer). The Softmax layer 414 finally outputs the sentiment category 402 to be assigned to the set of words 404. This already been explained in detail in conjunction with FIG. 3.

Referring now to FIG. 5, a flowchart of a method for generating a summary from unstructured text based on relevancy scores determined for each neuron associated with words in the plurality of sets of words and a theme selected by a user is illustrated, in accordance with an embodiment. At step 502, for a sentiment category associated with a theme selected by the user, the relevancy score determined for each neuron associated with each word in one or more of the plurality of sets of words that is assigned the sentiment category is compared with a first threshold relevancy score. The first threshold relevancy score may be specific to the sentiment category. In other words, when a user selects a theme, a sentiment category associated with that theme may be determined. Thereafter, for a give set of words (for example, a TWEET), relevancy score is determined for a neuron representing each word in the set of words. The relevancy scores are then compared with a first relevancy threshold associated with the sentiment category. This would be repeated for each set of words assigned to the sentiment category. By way of an example, if the user selected positive feedback as the theme, for a given TWEET that has been assigned positive sentiment category, the contribution of each word in that TWEET toward the positive sentiment (or the theme selected by the user) is determined.

At step 504, a plurality of words is selected from the one or more of the plurality of sets of words in response to the comparing. The relevancy scores of neurons associated with the plurality of words is above the first threshold relevancy score. In other words, for a given set of words, those words for which associated relevancy scores are greater than the first threshold relevancy score, are selected. In continuation of the example above, those words in the TWEET, for which the contribution toward the positive sentiment is more than a threshold, are selected for further analysis. At step 506, a predefined template associated with the sentiment category may be populated with the plurality of words selected at step 504, to generate the summary. In an embodiment, a rule based slot filling approach may be executed, such that, designated slots in a predefined summary template are filled with one or more of the plurality of words.

In an alternate embodiment, after step 504, at step 506, an encoder of a second neural network may receive word embeddings of the plurality of words. The second neural network may be trained to generate natural language sentences based on input words. Thereafter, at step 508, the encoder may generate an intermediate representation for each of the plurality of words. At step 510, a decoder of the second neural network may process the intermediate representation for each of the plurality of words and the theme selected by the user to generate the summary. The step 510 may include, selecting, at step 510a, a subset of words from the plurality of words, such that, relevancy score determined for neurons associated with the subset of words is greater than a second threshold relevancy score.

In an embodiment, the second neural network, for example may be seq2seq. The second neural network may initially be trained to generate human comprehendible sentences with the correct form and structure, from a set of high impact words that bear the key to the polarity of a set of reviews. The second neural network may also have a fixed size vocabulary to generate the output (i.e., summary). Once the neural network is trained, the plurality of words is fed into to the neural network to generate the summary. Relevant words for positive reviews may be used to generate the positive review summary. Similarly, the relevant tokens for negative reviews are used to generate the negative review summary.

In an embodiment, the encoder may be variant of an RNN, which generates an intermediate representation for the plurality of words. The intermediate representation is then fed into the Decoder along with an attention feature, that corresponds to the objective (or the theme) of the user. This results is further narrowing down the plurality of words the subset of words that are more important or relevant to the theme selected by the user. The decoder may also be an RNN variant, for example, an LSTM. The output for the decoder may be passed into a Softmax layer, which generates the final output, i.e., the summary, based on the vocabulary given to the second neural network. The second neural network may also take care on semantics, as the text fed in to the second neural network is in the form of word embeddings, hence the second neural network may take care of similar words and contexts.

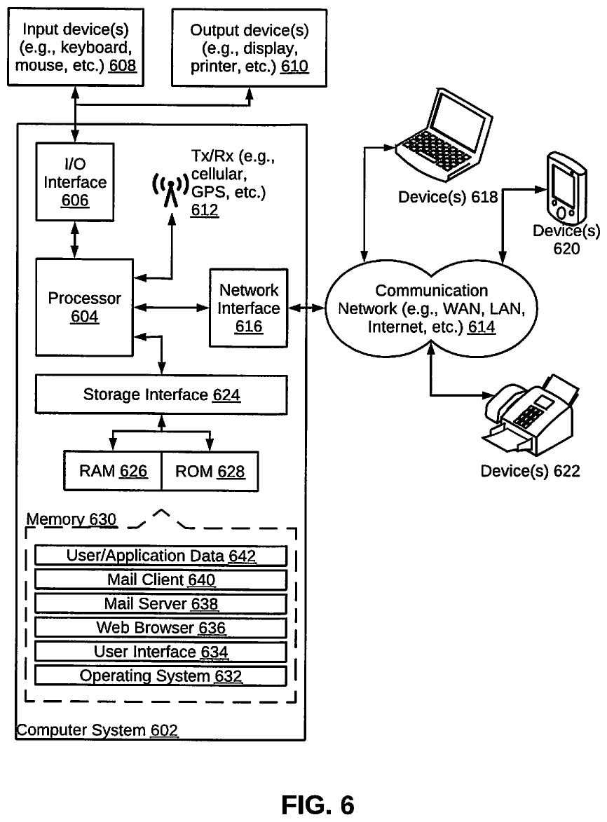

FIG. 6 is a block diagram of an exemplary computer system for implementing various embodiments. Computer system 602 may include a central processing unit (“CPU” or “processor”) 604. Processor 604 may include at least one data processor for executing program components for executing user- or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide system and method for generating theme based summary from unstructured content. The proposed method automatically extracts relevant data from the web and performs deep contextual understanding of customer feedback. The proposed method generates contextual summarization of customer feedback to output feedback pertaining to a use case or theme.

The specification has described system and method for generating theme based summary from unstructured content. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile

What is claimed is:

1. A method for generating theme based summary from unstructured content, the method comprising:
assigning, by a content summarizing device, a sentiment category of a plurality of sentiment categories to each of a plurality of sets of words extracted from an unstructured content, based on a first neural network comprising a plurality of layers, wherein a first layer of the plurality of layers receives unstructured content and a last layer of the plurality of layers generates sentiment categories for each of the plurality of sets of words, and wherein the unstructured content is associated with a topic category assigned by a user;
segregating, by the content summarizing device, the plurality of sets of words based on the assigned sentiment category;
processing for each of the plurality of sets of words, by the content summarizing device, each word in a set of words of the plurality of sets of words as a neuron in the first neural network, through an explainable extraction algorithm;
determining for each of the plurality of sets of words, by the content summarizing device, a relevancy score for each neuron relative to an associated sentiment category, based on an activation function associated with the explainable extraction algorithm; and
generating, by the content summarizing device, a summary from the unstructured text, based on the relevancy score determined for each neuron associated with each word in the plurality of sets of words and a theme selected by the user within the topic category, wherein the theme selected by the user is associated with at least one of the plurality of sentiment categories.

2. The method of claim 1, wherein the sentiment category comprises at least one of a positive sentiment category, a negative sentiment category, or a neutral sentiment category.

3. The method of claim 1 further comprising scraping the unstructured content from at least one data source based on the topic category assigned by the user.

4. The method of claim 1, wherein the relevancy score determined for a neuron relative to an associated sentiment category indicates relevancy of a word associated with the neuron to the associated sentiment category.

5. The method of claim 1, wherein generating the summary from the unstructured text comprises comparing, for a sentiment category associated with the theme, the relevancy score determined for each neuron associated with each word in one or more of the plurality of sets of words assigned the sentiment category with a first threshold relevancy score for the sentiment category.

6. The method of claim 5, further comprising selecting a plurality of words from the one or more of the plurality of sets of words in response to the comparing, wherein relevancy scores of neurons associated with the plurality of words is above the first threshold relevancy score.

7. The method of claim 6, further comprising populating a predefined template associated with the sentiment category with the plurality of words to generate the summary.

8. The method of claim 6, further comprising:
receiving, by an encoder of a second neural network, word embedding of the plurality of words, wherein the second neural network is trained to generate natural language sentences based on input words;
generating, by the encoder an intermediate representation for each of the plurality of words; and
processing, by a decoder of the second neural network, the intermediate representation for each of the plurality of words and the theme selected by the user to generate the summary.

9. The method of claim 8, wherein processing comprises selecting a subset of words from the plurality of words, wherein relevancy score associated with neurons associated with the subset of words is greater than a second threshold relevancy score.

10. The method of claim 1, further comprising presenting the summary to the user in a predefined format specified by the user.

11. A system for generating theme based summary from unstructured content, the system comprising:
a processor; and
a memory communicatively coupled to the processor, wherein the memory stores processor instructions, which, on execution, causes the processor to:
assign a sentiment category of a plurality of sentiment categories to each of a plurality of sets of words extracted from an unstructured content, based on a first neural network comprising a plurality of layers, wherein a first layer of the plurality of layers receives unstructured content and a last layer of the plurality of layers generates sentiment categories for each of the plurality of sets of words, and wherein the unstructured content is associated with a topic category assigned by a user;
segregate the plurality of sets of words based on the assigned sentiment category;
process for each of the plurality of sets of words each word in a set of words of the plurality of sets of words as a neuron in the first neural network, through an explainable extraction algorithm;
determine for each of the plurality of sets of words a relevancy score for each neuron relative to an associated sentiment category, based on an activation function associated with the explainable extraction algorithm; and
generate a summary from the unstructured text, based on the relevancy score determined for each neuron associated with each word in the plurality of sets of words and a theme selected by the user within the topic category, wherein the theme selected by the user is associated with at least one of the plurality of sentiment categories.

12. The system of claim 11, wherein the sentiment category comprises at least one of a positive sentiment category, a negative sentiment category, or a neutral sentiment category.

13. The system of claim 11 further comprising scraping the unstructured content from at least one data source based on the topic category assigned by the user.

14. The system of claim 11, wherein the relevancy score determined for a neuron relative to an associated sentiment category indicates relevancy of a word associated with the neuron to the associated sentiment category.

15. The system of claim 11, wherein generating the summary from the unstructured text comprises comparing, for a sentiment category associated with the theme, the relevancy score determined for each neuron associated with each word in one or more of the plurality of sets of words assigned the sentiment category with a first threshold relevancy score for the sentiment category.

16. The system of claim 15, further comprising selecting a plurality of words from the one or more of the plurality of sets of words in response to the comparing, wherein relevancy scores of neurons associated with the plurality of words is above the first threshold relevancy score.

17. The system of claim 16, further comprising populating a predefined template associated with the sentiment category with the plurality of words to generate the summary.

18. The system of claim 16, further comprising:
receiving, by an encoder of a second neural network, word embedding of the plurality of words, wherein the second neural network is trained to generate natural language sentences based on input words;
generating, by the encoder an intermediate representation for each of the plurality of words; and
processing, by a decoder of the second neural network, the intermediate representation for each of the plurality of words and the theme selected by the user to generate the summary.

19. The system of claim 18, wherein processing comprises selecting a subset of words from the plurality of words, wherein relevancy score associated with neurons associated with the subset of words is greater than a second threshold relevancy score.

20. A non-transitory computer-readable storage medium having stored thereon, a set of computer-executable instructions causing a computer comprising one or more processors to perform steps comprising:
assigning a sentiment category of a plurality of sentiment categories to each of a plurality of sets of words extracted from an unstructured content, based on a first neural network comprising a plurality of layers, wherein a first layer of the plurality of layers receives unstructured content and a last layer of the plurality of layers generates sentiment categories for each of the plurality of sets of words, and wherein the unstructured content is associated with a topic category assigned by a user;
segregating the plurality of sets of words based on the assigned sentiment category;
processing for each of the plurality of sets of words each word in a set of words of the plurality of sets of words as a neuron in the first neural network, through an explainable extraction algorithm;
determining for each of the plurality of sets of words a relevancy score for each neuron relative to an associated sentiment category, based on an activation function associated with the explainable extraction algorithm; and
generating a summary from the unstructured text, based on the relevancy score determined for each neuron associated with each word in the plurality of sets of words and a theme selected by the user within the topic category, wherein the theme selected by the user is associated with at least one of the plurality of sentiment categories.
